(19) United States
(12) Patent Application Publication
(10) Pub. No.: US 2007/0173138 A1
(43) Pub. Date: Jul. 26, 2007

(54) Contact used in an electrical connector

(75) Inventors: (Nick) Nan-Hong Lin, Tu-Cheng (TW); Fu-Pin Hsieh, Tu-Cheng (TW); Fang-Jun Liao, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/656,082

(22) Filed: Jan. 22, 2007

(30) Foreign Application Priority Data
Jan. 20, 2006 (TW) 95201399

(51) Int. Cl. H01R 13/02

(52) U.S. Cl. 439/884

(57) ABSTRACT

An conductive contact (100) includes a base portion (32) extending along a right direction, a contacting portion (31) extending upwardly from the base portion (32), a tail (33) formed on a distal end thereof. Wherein the base portion (32) connects the tail (33) with a transitional portion (35) and the transitional portion (35) comprises at least one twist portion (352).

### BACKGROUND OF THE INVENTION

1. Field of the Invention

The present invention generally relates to contacts. And more particularly, one embodiment of the present invention relates to an electrical contact for connecting a chip module with a printed circuit board.

2. General Background

Contacts are widely used in various electrical connectors for forming electrical connection between two separate electrical interfaces, such as an electronic component and a printed circuit board. Referring to FIGS. 1-3, a conventional contact 100 connecting the chip module 30 and the printed circuit board 60 basically includes a contacting portion 31 for abutting against the chip module 30, a securing portion 32 extending along a right direction, a tail portion for attaching to the printed circuit board and a connecting portion connecting the tail 33 with the securing portion 32. The securing portion 32 defines a number of barbs 321 for interferentially engaging with housing. The connecting portion 35 is connecting with the tail portion with a smooth arched surface, hence the contact 100 can provide a flexibility in a Z direction and a Y direction. The Z direction is a direction of the securing portion 32 extending along and the Y direction is a direction of the tail portion extending from the securing portion 32.

However, with the development of the chip module 30 forward high density and minimized size, the arrangement of contacts 100 received in the electrical connector is more and more compact. While the contacts 100 bear greater and more complicate force, the contacts 100 with minimized size and greater flexibility are more and more needed. In the contact described in above paragraph, the contact only provides flexibility in Z and Y directions, which can not meet the need of multi-directional flexibility of the contacts.

Therefore, there is a heretofore unaddressed need in the industry to address the aforementioned deficiencies and inadequacies.

### SUMMARY

According to an embodiment of the present invention, an conductive contact includes a base portion extending alonyoug a right direction, a contacting portion extending upwardly from the base portion, a tail formed on a distal end thereof. Wherein the base portion connects the tail with a transitional portion and the transitional portion comprises at least one twist portion.

In relative to the conventional technology, the contact defines a twist portion, hence improving a flaw that the contact can only provide flexibility in two directions. Furthermore, the resistance capability and the durability of the contacts are attained, and the electrical and mechanical connection between the chip module and the printed circuit board can be assured.

The present invention is illustrated by way of example and not limitation in the figures of the appended drawings, in which like references indicate identical elements, and in which:

### BRIEF DESCRIPTION OF THE DRAWINGS

FIG. 1 depicts an exemplary cross-sectional view of a conventional electrical connector, wherein the contact has been inserted into the housing;

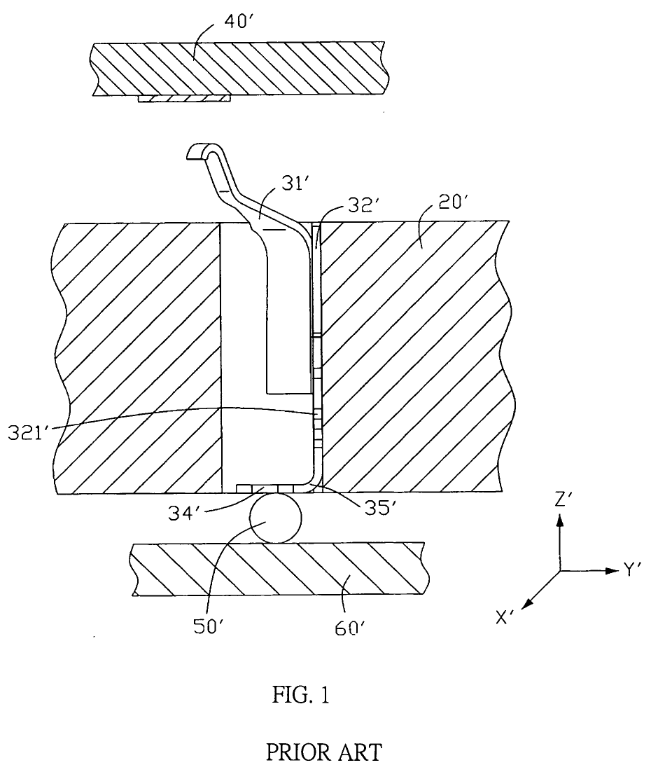

FIG. 2 depicts an exemplary isometric view of a conductive contact shown in FIG. 1;

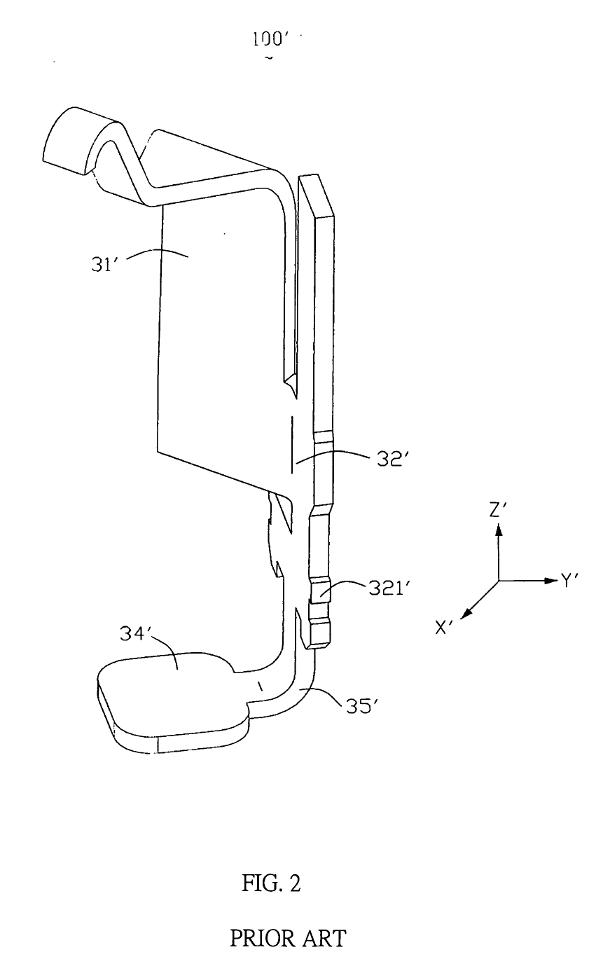

FIG. 3 depicts an exemplary isometric view of a contact in accordance with the embodiment of the invention;

### DETAILED DESCRIPTION OF THE EMBODIMENTS

In the following description, for purpose of explanation, numerous details are set forth in order to provide a thorough understanding of the embodiments of the present invention. However, it will be apparent to one skilled in the art that these specific details are not required in order to practice the embodiments of the present invention.

The following description includes terms such as upper, lower, upwardly and the like, that are used for descriptive purpose only and are not to be construed as limiting. That is, these terms are terms that are relative only to a point of reference and are not meant to be interpreted as limitation but are instead, included in the following description to facilitate understanding of the various aspects of the present invention.

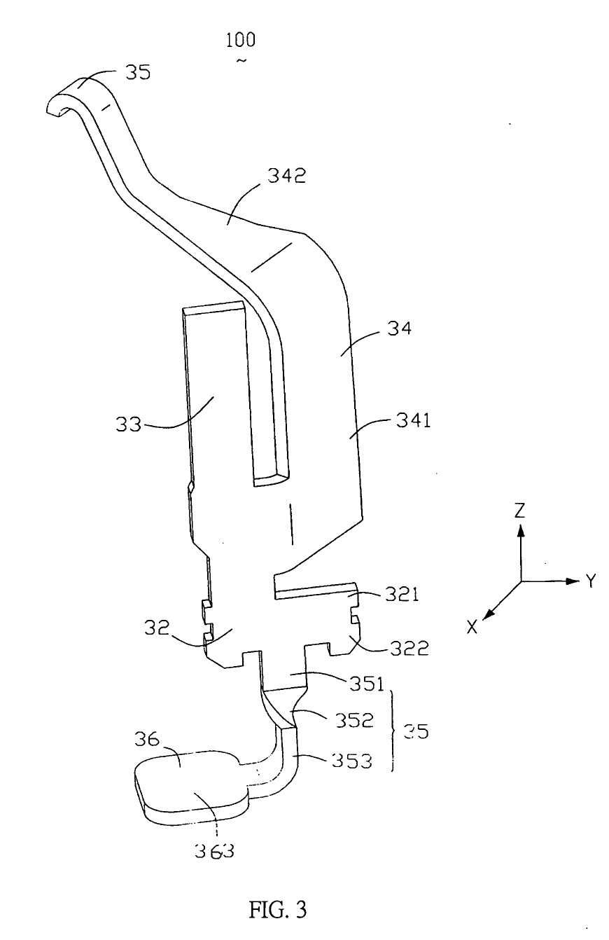

Referring to FIG. 3, a conductive contact 3 according to a preferred embodiment of the present invention, is mainly used to electrically connect two electrical components, e.g. an IC package and a PCB, but not limited thereto comprises.

Referring also to FIG. 3, each contact 100 in light of the embodiment of the present invention is formed from conductive material and has a vertical plate-like base 32 with a major vertical surface 321. A plurality of barbs 322 is formed on opposite lateral sides of the base 32, for being engagingly received in corresponding slots of a housing.

For more securable position of the contact 100 in a corresponding passageways of the housing, an upright rectangular plate-like head portion 33 coplanarly projecting from a top end of the base 32, for being secured in the housing. It should be understood that the head portion 33 can be configured to have other configurations for fitting the others configurations of the housing.

A tail 36 is connected to a bottom end of the base 32, having a vertical position with respect to the base 32. The tail 36 has a relatively larger bottom surface 360 vertical to the major surface 320 of the base 32 and adapted to engage a solder member, e.g. solder ball, thereby establishing electrical engagement between the contact and the PCB.

A transitional portion 35 is provided to connect the tail 36 and the base 32. The transitional portion 35 comprises a vertical extending portion 351 extending from the base portion 32, a twist portion 352 is reversed in a clockwise direction, a connecting portion 353 connecting the twist portion 352 and the tail portion 36 wherein the reverse direction of the twist portion 352 can be defined in a reverse hour and the twist portion 352 can be defined on different positions of the transitional portion 35 for providing a altering flexibility to the contact 100. In this embodiment the disposition of the twist portion 352 can provide flexibility in X direction, besides the Y and Z direction. In addition, the width and the number of the twist portion 352 can be altered in line of the flexibility required in a environment test, the stretching or pressing force applied on the contact 100 by the printed circuit board or test tools can be eased by the twist portion 352. The twist portion 352 can provide flexibility in three directions, which makes the contact avoid wreck or crush by an outer force and ensure a stable and reliable connection between the chip module and the printed circuit board.

An arm portion 34 is bent or extended from a lateral edge of the head portion 33 at an obtuse angle. To make the arm portion 34 longer, the arm portion 34 is devised to have a curved configuration with an upwardly retention portion 341 and an upwardly and forwardly spring portion 342 originating from a distal end of the extending portion 340 along another direction X.

The contact 100 further has an arced or curved contacting portion 35 formed at a topmost part thereof with its distal end facing downwardly. The contacting portion 35 is formed at a distal end of the arm portion 34 and has an arced or curved upper surface for electrically engagingly mating with a corresponding conductive pad of the IC package. From a top view of the contact 100, a projection of the arm portion 34 extends at an acute angle with respect to a projection of the base 32.

With the configuration of the contact 100, the arm portion 34 extends in a curve way and is devised to make the good use of a space of a corresponding housing, thereby the arm portion 34 can be relatively long.

After assembly, the arm portion 34 has an upper part of the upwardly and forwardly spring portion 342 projected beyond the top surface of the housing. The raised contacting portion 35 is at a topmost position of the contact 100 in an upright direction vertical to the top surface or the mounting surface, and ready to electrically engage a corresponding pad of the chip. Thus, the contact 100 is completely planted on the housing.

With this arrangement design of the contact 100, when the IC package is pressed down, the conductive pad has a bottom surface pressed the contacting portion 35 of the contact 100 to urge the arm portion 34 of the contact 100 to resiliently deform down. Because the contact 100 has the above-described transitional portion with good resilient characteristics, flexibility can be gained to assure good engagement between the chip module and the contact 100.

In connection with the preceding description, the electrical connectors in accordance with embodiments of the present invention can create multi-directional flexibility effect, which possibly optimize electrical and mechanical connection between contacts and the printed circuit board during signal transmission.

While the present invention has been illustrated by description of embodiments thereof, and while the embodiments have been described in considerable detail, it is not intended to restrict or in any way limit the scope of the appended claims to such details. Additional advantages and modifications in the spirit and scope of the present invention will readily appear to one skilled in the art. Therefore, the present invention is not limited to the specific details and illustrative examples shown and described.

1. A conductive contact for establishing electrical connection between a chip module and a printed circuit board, the conductive contact comprising:
a base portion comprising a bridging portion extending from the base portion;
a contacting portion is oriented above the bridging portion, and the contacting portion is connected with the base portion by the bridging portion;
a tail portion extending from the base portion providing a platform for attaching a solder joint thereon;
wherein the tail portion includes a stem connected to the base, and which is transitionally rotated to a certain degree such that a line extending along an edge of the base portion substantially intersect the platform of the tail portion.

2. The contact of claim 1, the transitional portion comprises at least one twist portion.

3. The contact of claim 1, wherein the transitional portion further comprises an extending portion extending from a lower end of the base portion and a connecting portion connecting with the twist portion.

4. The contact of claim 1, wherein the twist portion can be defined on any position of the transitional portion.

5. The contact of claim 1, wherein width of twist portion can be altered in accordance with a desired flexibility.

6. The contact of claim 1, wherein the base portion defines a number of barbs on lateral sides thereof.

7. A conductive contact for establishing electrical connection between a chip module and a printed circuit board, the conductive contact comprising:
a base portion fundamentally extending in a upright direction;
a contacting portion disposed on a top end of the contact for contacting with the chip module;
a head portion extending from the base portion;
an arm portion bendly and upwardly extending from a sidewall of the head portion;
a transitional portion extending from a distal end of the base portion comprising at least one twist portion.

8. A conductive contact for establishing electrical connection between a chip module and a printed circuit board, the conductive contact comprising:
a base portion fundamentally extending in an upright direction and defining a retention structure thereon;
an arm portion angled an acute angle with the base portion;
a contacting portion extending from a distal end of the arm portion for contacting with the chip module;
a tail portion located below a bottom portion of base portion for connecting with the printed circuit board; and
a transitional portion connected between the base portion and the tail portion; wherein
the tail portion essentially extends along a direction parallel to the base portion.

9. The contact as claimed in claim 8, wherein the transitional portion is in a twisted form.

10. The contact as claimed in claim 9, wherein the base portion is located in a central vertical plane of the tail portion.
